(19) United States
(12) Patent Application Publication
(10) Pub. No.: US 2022/0281314 A1
(43) Pub. Date: Sep. 8, 2022

(54) NEW-GENERATION FUEL TANK CONNECTION

(71) Applicant: FNSS SAVUNMA SISTEMLERI A.S., GÖLBASI (TR)

(72) Inventor: GÖKTUG BURAK ÇALIK, GÖLBASI (TR)

(21) Appl. No.: 17/298,970

(22) PCT Filed: Nov. 6, 2020
(86) PCT No.: PCT/TR2020/051053

§ 371 Date: Jun. 2, 2021

(30) Foreign Application Priority Data
Nov. 22, 2019 (TR) 2019/18240

(51) Int. Cl. B60K 15/04

(52) U.S. Cl. CPC B60K 15/04; B60K 2015/0496; B60K 2015/0474

(57) ABSTRACT

The invention is related to a new-generation fuel tank connection in all kinds of military vehicles, which enables a space reserved for the fuel tank to be used more efficiently, by reducing mounting space required according to the conventional methods. The invention is especially related to a new-generation fuel tank connection which comprises a sealed gasket (60) which has connection holes (62) to attach connection pieces (30) on the tank, which is produced from the materials suitable with fuel, which serves as leaking and vibration damping between fuel tank and sealing element (20), which has a conicity (64) in its inner surface (63) for ease of mounting of the sealing element (20), and a sealing element (20) which connects to the support (120) located on the vehicle roof (130) through connection holes (23) with connection pieces (30) and of which part entering into (63) the sealed gasket (60) tightened with clamp (50) has a conical (22) structure.

### TECHNICAL FIELD

The invention is related to a new-generation fuel tank connection in all kinds of military vehicles, which enables a space reserved for the fuel tank to be used more efficiently, by reducing mounting space required compared to the conventional methods.

The invention is especially related to a new-generation fuel tank connection which comprises a sealed gasket which has connection holes to attach connection pieces on the tank, which is produced from the materials suitable with fuel, which serves as leaking and vibration damping between fuel tank and sealing element, which has a conicity in its inner surface for ease of mounting of the sealing element, and a sealing element which connects to the support located on the vehicle roof through connection holes with connection pieces and of which part entering into the sealed gasket tightened with clamp has a conical structure.

### STATE OF THE ART

In parallel with improvement of technology, there has been great improvements also in military systems. Primary purposes of these improvements are to make military vehicles fast, comfortable, useful and reliable. Today, the main task of the vehicle fuel tanks used in military vehicles is to maintain fuel and provide fuel to the engine. In addition to this, they also take part in the cooling process of the fuel. Fuel tanks should be produced from a material which does not react with the fuel. The materials used are generally aluminum and coated steel. The material used should not lose its properties over time. Galvanized steel plates are not preferred since they react with diesel. Fuel tank welds are the most important structure elements. All welds should be controlled after welding the fuel tank. Fuel tanks are critical systems for all vehicles. In the designs made in armored vehicles, fuel tanks can be used as being dependent on or independent from the vehicle.

In the present invention, there are advantages and disadvantages of the situations where the vehicle body is used as a fuel tank (dependent fuel tank). The most significant advantage is that the tank weight is eliminated and a light system is obtained. In addition to this, since the body is used as fuel tank, important situations such as welding, preventing the reaction of plates with fuel and sealing occur. The welds of the plates that form a tank region should be carefully thrown and then their sealing conditions should be tested. Moreover, different chemicals are applied over the welds in order to increase sealing. In the structures formed with steel plates, chemical protection should be applied on the plates contacting with fuel and paint providing a protective feature with fuel should be applied on all surfaces. Fuel tank region should be extra protected against external threats and this situation should be carried out by providing weight balance with independent fuel tanks.

In the present technique, in cases where the vehicle body is not used as a fuel tank (independent fuel tank), it does not pose any problem as it will accumulate in the reserved region in case that fuel leakage occur in the fuel tanks placed in an external closed partition. However, it occupies substantial place due to the fact that the reserved region is bigger than the tank and that there are fuel tank connections and vibration dampers. Empty area approximately up to the tank volume can be used based on the vehicle structure and design.

In the present technique, in situations where the vehicle body is not used as a fuel tank (independent fuel tank), a certain distance is required for mounting the bellows in case that sealing is provided between fuel tanks and roof plate by means of the bellows. The mounting of the bellows is done with a clamp over tank and structures located on the roof. A distance between 10-15 cm is kept between the roof and the fuel tank. In order to meet the volume requirements, the connection distance between the fuel tank and the vehicle body is needed to be increased.

In the present technique, in situations where the vehicle body is not used as a fuel tank (independent fuel tank), the body maintenance cover located on the tank can be enlarged in order to use the distance between the fuel tank and the roof plate for a wide cover/bellows solution. This design is quite hard to mount. Two different people should mount this together. The area used remains around 7-8 cm with this design. It is seen that the body maintenance cover occupies a certain area on the vehicle. This situation makes the fuel tank area an open target.

The most significant disadvantage of the designs used in the present technique is that their lengths are quite long in order to provide volume constraint. Each vehicle has different tank volume requirements in line with its performance requirements. A certain space should be left between the fuel tank and the vehicle's roof plate. The main reason for this is to prevent leaking of the fuel added into the vehicle during fuel filling.

Another problem encountered in the present technique is the difficulty of mounting. Bellows should be attached to the fuel tanks placed inside the vehicle and tightened with the help of clamps.

Another problem that cannot be prevented in the present technique is the accumulation of fuel inside the bellows added for fuel sealing and its usage as a tank element. This situation reduces the life of the bellows.

Consequently, for the solution of the above-mentioned problems existing in the present technique, the need for a new economical, useful, ergonomic and more functional new-generation tank connection and insufficiency of the present solutions have required an improvement in the relevant technical field.

### AIM OF THE INVENTION

The present invention is related to the new-generation fuel tank connection that allows the usage area to be increased by shortening the length of the fuel tank of all kinds of military vehicles developed to eliminate the above-mentioned disadvantages and bring new advantages to the relevant technical field.

The most important aim of the invention is to minimize the space of 10-15 cm which has to be provided between the fuel tank and the vehicle roof in the conventional method, and to shorten the length of the fuel tanks.

Another aim of the invention is to provide the sealing with or without a clamp.

Another aim of the invention is that it is easy to mount and demount and mounting and demounting process can be carried out by a single operator. In this way, labor costs are reduced. According to the conventional method, the order of mounting in this design varies as such: firstly, sealed gasket, then tank mounting and mounting of the sealed element added from the outside of the vehicle. Thanks to this feature of the design, there is no need for the mounting space required in the conventional method, only a space equal to the clamp thickness is left. This allows the space reserved for the fuel tank inside the vehicle to be used more efficiently, thus allowing usage of a bigger (elongated) fuel tank. With this feature of the design, mounting/demounting can be made more comfortably.

Another aim of the invention is to use one type of fuel tank in all armored vehicles independently from volume and material.

A new-generation fuel tank connection developed to realize all the aims mentioned above and being interpreted from the detailed description below; it comprises at least one sealed gasket which has connection holes to attach connection pieces on the tank, which is produced from the materials suitable with fuel, which serves as leaking and vibration damping between fuel tank and sealing element, which has a conical inner surface for ease of mounting of the sealing element, at least one sealing element which connects to the support located on the vehicle roof from connection holes with connection pieces and of which part entering into the sealed gasket tightened with clamp has a conical structure, a clamp which prevents diesel oil leakage between the sealed gasket and the sealing element and which does not damage the outside of the gasket, a stamp on which the sealed gasket is connected in order to press equally on the tank, a gasket ensuring sealing between the sealing element and the support welded to the vehicle roof, a support piece where the sealing gasket is connected with the connection pieces through its holes, a support where the sealing element is connected with the connection pieces through connection holes, an insert piece which is nailed on the slots of the connection pieces of the support pieces welded inside the tank and used to prevent deterioration of the tooth structures of aluminum surfaces.

The structural and characteristic features and all advantages of the invention will be understood more clearly by means of the figures given below and the detailed description written by referring to these figures, and therefore the evaluation should be made by taking these figures and detailed description into consideration.

### FIGURES FOR UNDERSTANDING THE INVENTION

FIG. 1; is a drawing showing the new-generation fuel tank connection subject to the invention.

FIG. 2; is a drawing cross-sectionally showing the new-generation fuel tank connection subject to the invention.

FIG. 3; is a drawing cross-sectionally showing the sealed gasket of the new-generation fuel tank connection subject to the invention.

FIG. 4; is a drawing showing the sealed element of the new-generation fuel tank connection subject to the invention.

FIG. 5; is a drawing showing the sealed element of the new-generation fuel tank connection subject to the invention.

### REFERENCE NUMBERS

10. Filling Cover
20. Sealing Element
21. Channels
22. Conicity
23. Connection Holes
30. Connection Pieces
40. Gasket
50. Sealing Clamp
60. Sealed Gasket
61. Sealed Channels
62. Holes
63. Inner Part
64. Conical Surface
70. Insert Piece
80. Fuel Filter
90. Support Piece
100. Fuel Tank Roof Plate
110. Stamp
120. Support
130. Vehicle roof Plate

### DETAILED DESCRIPTION OF THE INVENTION

In this detailed description, preferred embodiments of the new-generation fuel tank connection are described only for a better understanding of the subject and without having any limiting effect.

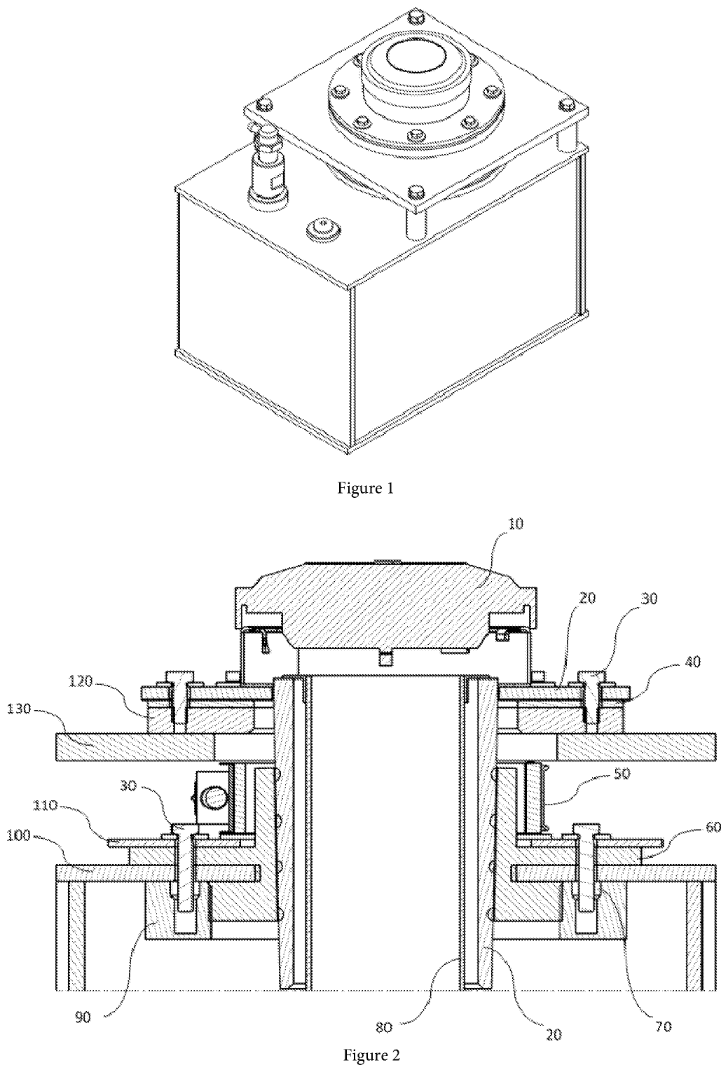

In the FIG. 1 and FIG. 2, the new-generation fuel tank connection subject to the invention is shown. According to the invention, the support piece (90) should be welded to the fuel tank roof (100) during manufacturing of fuel tank. There are holes (62) on the sealing gasket (60) to attach this sealing gasket on the tank with connection pieces (30). The sealing gasket (60) is connected to the support piece (90) with the connection pieces (30) through these holes (62). The new-generation sealing gasket (60) should be produced with a mold having a desired hardness. This is the most important piece in the designed system and this is made of materials suitable with fuel.

This serves as leaking and vibration damping between the fuel tank and one-piece sealing element (20) installed later in it. There is a channel (61) structure inside (63) to increase sealing. The inner surface (63) of the gasket (60) where channels (61) are located has a conical (64) structure for the ease of mounting gasket sealing and sealing element (20). One-piece welded sealing element (20) should be produced in desired conicity (22). The stamp (110), which is attached on the new-generation sealing gasket (60) to press equally on the tank and is preferably made of aluminum, is preferably made of 3 mm thickness in the design developed. By taking into consideration tightening portion of the gasket (60) under the stamp (110), it has been designed in a wider diameter than the gasket (60). Herein, insert pieces (70) are nailed on the connection piece slots of the support piece (90) welded inside the tank and used to prevent deterioration of the tooth structures of the aluminum surfaces.

A hole should be made in the vehicle roof plate (130) to pass through the sealing element (20) and the support (120) should be welded to attach the connection pieces. Fuel filter (80) is attached inside the sealing element (20) preferably made of aluminum and is tightened with a clamp (50). The clamp (50) has been designed especially for preventing leakage of diesel oil between sealed gasket (60) and sealing element (20). Inner gasket of the clamp (50) is made of a material which is suitable with fuel and which does not damage the outside of sealed gasket (60). All the surfaces of the clamp (50) are ensured to be equally tightened. The part where sealing element (20) enters into sealed gasket (60) is made in conical (22) structure.

With the newly developed system, a special sealed gasket (60) has been designed for the fuel filling neck. The sealed gasket (60) is attached to the roof plate (100) without the fuel tank being placed inside the vehicle. After the sealed gasket (60) is attached on the fuel tank, it is tightened on the tank with stamp (110). The sealing clamp (50) is loosely attached on the new-generation sealed gasket (60). The fuel tank is secured by matching the sealed gasket (60) located on the fuel tank placed inside the vehicle and the opening located in the body plate. One-piece welded sealing element (20), which is developed from vehicle roof into the sealed gasket (60) and has a conical (22) structure, is placed. Mold-release silicon or petrolatum can be used during mounting in order not to damage fuel and sealed gasket (60). Sealing element (20) is connected to the support (120) located on vehicle roof (130) with connection pieces (30) through connection holes (23). Sealing clamp (50) is tightened inside the vehicle and sealing is provided. Wherein gasket (40) provides sealing between sealing element (20) and support (130) welded to vehicle roof and preferably is made of nitrile material suitable with fuel.

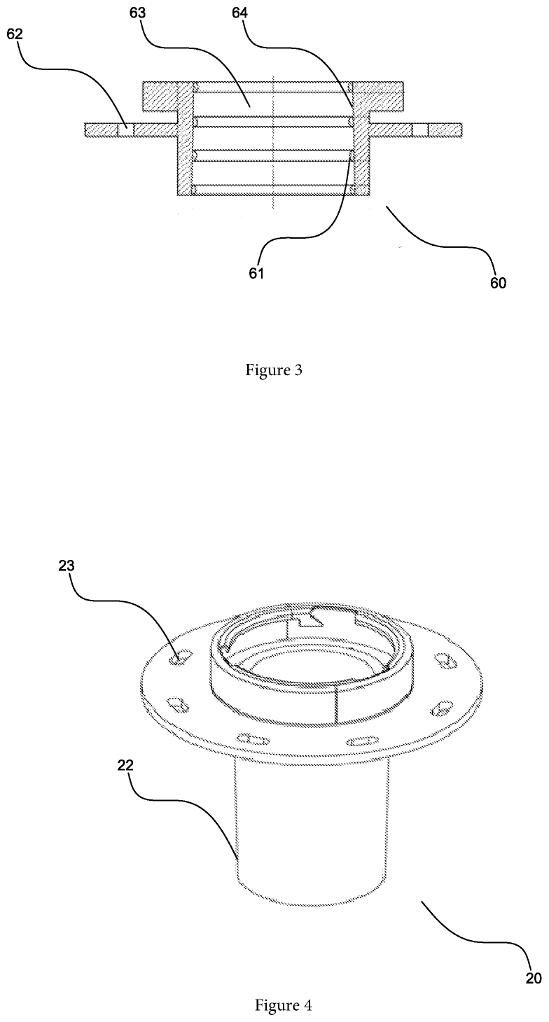

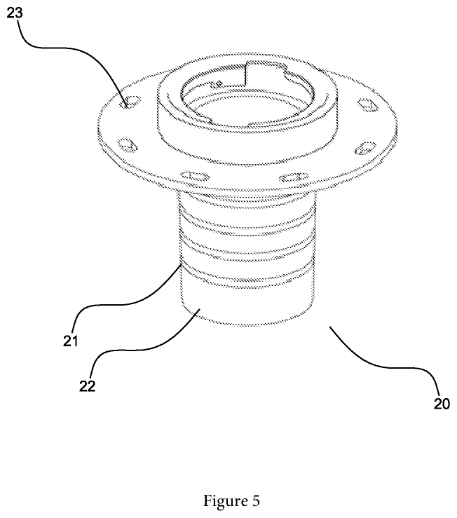

The sealing element (20) shown in FIG. 4 and FIG. 5 serves as filling cover (10) and sealing element. The conicity (64) of the sealed gasket (60) and the conicity (22) of the sealing element (20) match. In alternative embodiments of the sealing element (20), there are channels (21) on conical (22) part in order to increase sealing. There are channels (61) inside the new-generation sealed gasket (60) showed in FIG. 3 in order to increase sealing.

Prototypes have been produced and tested for new-generation fuel system. For the sealed gasket (60) used, various harnesses were tested as neoprene and nitrile. Tests made:
Mounting of fuel tank has been completed and air of 0.3 bar have been provided inside tank. In this test, Nitrile and Neoprene sealed gaskets (60) have been used. As a result of the test, there is no air leakage.
The tank has been completely filled with diesel oil and kept in reverse for 1 week. As a result of the test, there is no fuel leakage.
Nitrile and neoprene gaskets have been reversed and have been gradually subject to vibration and shake. As a result of this test, there is also no fuel leakage.

The Results obtained as a result of the tests made are as follows;
A new sealed gasket (60) produced with different degrees of hardness was observed;

Considering the mounting, it was observed that Neoprene gasket was more easily mounted but deformed too much when the bolts were tightened since it remained soft (40 shore). After the tests performed by reversing them, it was observed that the traces of bolt slot left a permanent trace similar to deformation on the Neoprene gasket. It was observed that nitrile gasket being harder was not very difficult to mount and its degree of hardness (50 shore) was more suitable for the place of use.
Welded (aluminum) sealing element (20) was observed;

The fuel filling neck produced as having channel (21) was mounted. It was observed that the channels may damage the gasket during demounting.
Sealing clamp (50) was observed; A special clamp gasket was used in order to tighten equally from every surface. Air leakage was observed with or without clamp attached in the 0.2 bar air test. In the tests made by reversing, it was observed that fuel proceeds to the surface which clamp tightens and the clamp holds fuel. It was observed that the gasket clamp can be selected slightly smaller than outer diameter of gasket surface and shortening the bolt would be easier in terms of mounting. The clamp was selected in such a way to be stainless and to be tightened from one side.

Protection scope of this application has been determined in the claims and it cannot be limited to those explained above for illustrative purposes. It is apparent that a person skilled in the art can introduce a novelty introduced in the invention by using similar configurations and/or apply this configuration in other fields with similar aims used in the relevant technique. Therefore, it is apparent that such configurations can be deprived of novelty and criteria regarding exceeding the state of art.

1. A new-generation fuel tank connection in all kinds of military vehicles, which enables a space reserved for the fuel tank to be used more efficiently, by reducing mounting space required according to the conventional methods, characterized by comprising;
at least one sealed gasket (60) which has connection holes (62) to attach connection pieces (30) on the tank, which is produced from the materials suitable with fuel, which serves as leaking and vibration damping between fuel tank and sealing element (20), which has a conicity (64) in its inner surface (63) for ease of mounting of the sealing element (20),
at least one sealing element (20) which connects to the support (120) located on the vehicle roof (130) through connection holes (23) with connection pieces (30) and of which part entering into (63) the sealed gasket (60) tightened with clamp (50) has a conical (22) structure.

2. New-generation fuel tank connection according to the claim 1, characterized by comprising a clamp (50) which prevents leakage of diesel oil between sealed gasket (60) and sealing element (20) and does not damage outside of the gasket (60).

3. New-generation fuel tank connection according to the claim 1, characterized by comprising stamp (110) on which the sealed gasket (60) is connected in order to press equally on tank.

4. New-generation fuel tank connection according to the claim 1, characterized by comprising a gasket (40) which provides sealing between sealing element (20) and support (120) welded to vehicle roof (130).

5. Sealed gasket (60) according to claim 1, characterized by comprising channels (61) which ensure sealing to be increased in its inner part (63).

6. Sealing element (20) according to claim 1, characterized by comprising channels (21) which ensure sealing to be increased in its conical surface (22).

7. New-generation fuel tank connection according to the claim 1, characterized by comprising a support piece (90) where the sealing gasket (60) is connected with connection pieces (30) through its holes (62).

8. New-generation fuel tank connection according to the claim 1, characterized by comprising support (120) where the sealing element (20) is connected with connection pieces (30) through its holes (23).

9. New-generation fuel tank connection according to the claim 1, characterized by comprising an insert piece (70) which is nailed on the slots of the connection pieces of the support piece (90) welded inside the tank and used to prevent deterioration of the tooth structures of aluminum surfaces.
